(19) United States
(12) Patent Application Publication
(10) Pub. No.: US 2012/0113084 A1
(43) Pub. Date: May 10, 2012

(54) LIQUID CRYSTAL DISPLAY DEVICE AND DRIVING METHOD OF THE SAME

(75) Inventors: Hyo-Sang Yang, Yongin-city (KR); Byung-Chang Shim, Yongin-city (KR); Dong-Wan Choi, Yongin-city (KR); Seo-Hee Ha, Yongin-city (KR); Hee-Kwon Eun, Yongin-city (KR)

(73) Assignee: Samsung Mobile Display Co., Ltd., Yongin-city (KR)

(21) Appl. No.: 13/207,379

(22) Filed: Aug. 10, 2011

(30) Foreign Application Priority Data
Nov. 10, 2010 (KR) 10-2010-0111466

(51) Int. Cl. G09G 5/00; G09G 3/36

(52) U.S. Cl. 345/212; 345/87

(57) ABSTRACT

A liquid crystal display (LCD) and a driving method thereof are disclosed. According to some aspects the liquid crystal display (LCD) includes: a display unit including a plurality of pixels arranged in a matrix, a gate line respectively connected to the plurality of pixel rows, and a data line respectively connected to a plurality of pixel columns. The LCD further includes a gate driver configured to generate and sequentially transmit a plurality of gate signals to a plurality of pixel rows through the gate line by row to turn on a switch included in the pixel. The LCD further includes a data driver configured to apply a data voltage according to an image data signal to the pixel during a period in which the switch is turned on; and a common voltage generator configured to generate and apply a common voltage having a polarity that is opposite to the polarity of the data voltage to the pixel. According to some aspects, the period in which the switch is turned on includes a first period and a second period that are separated from each other by a period in which the data voltage is transmitted to at least one pixel row, and during the first period, as a voltage according to a difference between the data voltage transmitted to the pixel and the common voltage applied to the pixel, a voltage for displaying a black image according to a liquid crystal mode of the display unit is stored to the pixel.

### CROSS-REFERENCE TO RELATED APPLICATIONS

This application claims priority to and the benefit of Korean Patent Application No. 10-2010-0111466 filed in the Korean Intellectual Property Office on Nov. 10, 2010, the entire contents of which are incorporated herein by reference.

### BACKGROUND

1. Field

The disclosed technology relates to a liquid crystal display (LCD) and a driving method thereof. More particularly, the disclosed technology relates to a liquid crystal display (LCD) with improved after-image or sticking effect. An after-image or sticking effect refers to an image which continues to appear after the original image has been displayed by the LCD. It is desirable to form a system which has an improved after-image that does not include insertion of black data during display of a video signal in a liquid crystal display (LCD) displaying the images.

2. Description of the Related Technology

In general, a liquid crystal display (LCD) includes a display panel having two substrates and a liquid crystal layer having an anisotropic dielectric constant interposed therebetween, and a driving circuit unit driving the display panel. The driving circuit forms an electric field between the two substrates of the LCD to control light transmittance of the liquid crystal layer according to the intensity of the electric field, thereby displaying images.

The display panel includes a matrix of pixel units which are driven by a plurality of gate wires and data wires. Each pixel unit includes a thin film transistor, a liquid crystal capacitor, and a storage capacitor. The liquid crystal capacitor includes two terminals of a pixel electrode connected to a thin film transistor and a common electrode supplied with a common voltage, and a liquid crystal layer functioning as a dielectric material.

The pixel electrode connected to the thin film transistor is charged by a data signal transmitted though the data wires. However, when an electric field is applied to the liquid crystal layer in one direction for a long duration, reduced performance of the LCD occurs. Therefore, in order to prevent this reduced performance, the polarity of a data voltage with respect to the common voltage is inverted for every frame, every column, or every pixel. Alternatively, the data voltage and the common voltage are driven to be inverted such that they have an inverse polarity with respect to each other.

For example, a line inversion method in which the common voltage that is inverted per horizontal pixel row as a unit may be applied to a small and medium size display device.

However, if a driving frequency is increased in the liquid crystal display (LCD), the after-image effect or the sticking effect is caused.

In the conventional liquid crystal display (LCD), to prevent the after-image or the sticking effect, black image data is inserted after the image data displaying a normal screen is input. As a result, the luminance is decreased, the frequency is increased per frame, and the power consumption is increased.

Alternatively, instead of the method of removing the instant after-image by inserting the black image data, a technique of improving the instant after-image effect by reducing the aperture ratio of the pixel is proposed. However, reducing the aperture ration of the pixel decreases the luminance such that it is difficult to realize a screen display for high image quality. Accordingly, research of a driving technique realizing an image display of high image quality and removing after-image and sticking effect is required.

The above information disclosed in the Background section is only for enhancement of understanding of the background of the invention and therefore it may contain information that does not form the prior art that is already known to a person of ordinary skill in the art.

### SUMMARY OF CERTAIN INVENTIVE ASPECTS

According to some aspects, a liquid crystal display (LCD) is disclosed. The LCD includes a display unit including a plurality of pixels arranged in a matrix, a plurality of gate lines respectively connected to a plurality of pixel rows, a plurality of data lines respectively connected to a plurality of pixel columns, a plurality of switches respectively connected to the plurality of pixels, a gate driver configured to generate and sequentially transmit a plurality of gate signals to a plurality of pixel rows through the gate lines by row to turn on a switch of the plurality of switches included in the pixel, a data driver configured to apply the data voltage according to an image data signal to the pixel during a period in which the switch is turned on, and a common voltage generator configured to generate and apply a common voltage having a polarity that is opposite to a polarity of the data voltage to the pixel. The period in which the switch is turned on includes a first period and a second period that are separated from each other by a period in which the data voltage is transmitted to at least one pixel row, and during the first period, a voltage for displaying a black image according to a liquid crystal mode of the display unit is stored in the pixel. The voltage stored in the pixel corresponds to a voltage difference corresponding to a difference between the data voltage transmitted to the pixel and the common voltage applied to the pixel.

According to some aspects, a method for driving a liquid crystal display (LCD) including a plurality of pixels is disclosed. The method includes a black insertion period prior to an image display period for displaying a corresponding image to a plurality of pixel rows. The method further includes transmitting a gate signal of a gate-on voltage level to a gate line connected to a predetermined pixel row at a start period of the black insertion period, transmitting the gate signal of the gate-on voltage level to the gate line connected to the predetermined pixel row at the image display period, and storing a voltage for displaying a black image according to a liquid crystal mode for the display unit to the plurality of pixels during a start period. The voltage stored to the plurality of pixels corresponds to a voltage according to a difference between the data voltage transmitted to a plurality of pixels included in the predetermined pixel row and the common voltage applied to the plurality of pixels.

### BRIEF DESCRIPTION OF THE DRAWINGS

FIG. 1 is a block diagram of a liquid crystal display (LCD) according to some embodiments.

FIG. 2 shows a driving waveform of a driving method of a liquid crystal display (LCD) according to some embodiments which is driven in a normally white mode.

FIG. 3 is a view showing an image display of a display unit according to the driving waveform of FIG. 2.

FIG. 4 shows a driving waveform of a driving method of a liquid crystal display (LCD) according to some embodiments.

FIG. 5 is a driving waveform of a driving method of a liquid crystal display (LCD) according to some embodiments which is driven in a normally black mode.

FIG. 6 is a view showing image display of a display unit according to the driving waveform of FIG. 5.

### DETAILED DESCRIPTION OF CERTAIN INVENTIVE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

Constituent elements having the same structures throughout the various embodiments are denoted by the same reference numerals and may only be described once. In the other embodiments, only constituent elements other than the same constituent elements will be described.

In addition, parts not related to the description are omitted for clear description of the present invention, and like reference numerals designate like elements and similar constituent elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

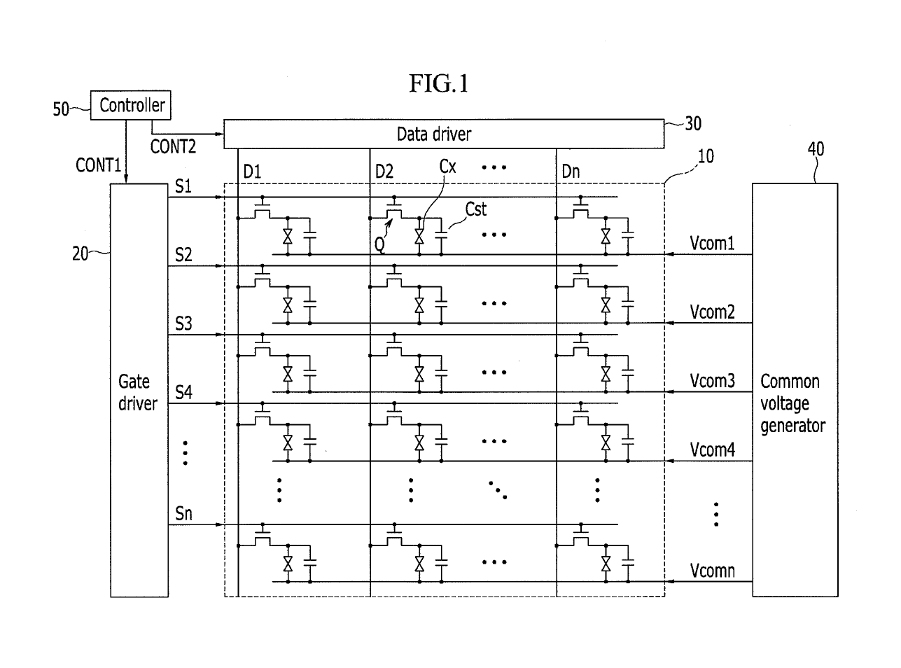

FIG. 1 is a block diagram of a liquid crystal display (LCD) according to some embodiments.

A liquid crystal display (LCD) according to some embodiments includes a display unit 10 including a plurality of pixels, a gate driver 20, a data driver 30, a common voltage generator 40, and a controller 50 controlling them.

The display unit 10 includes a plurality of pixels positioned in regions where a plurality of gate lines and a plurality of data lines are intersected and connected to the corresponding gate lines of the plurality of gate lines. The corresponding data lines among the plurality of data lines, and the plurality of pixels are approximately arranged in a matrix format.

The plurality of gate lines extend in a row direction of a plurality of pixels, and the plurality of data lines extend in a column direction of a plurality of pixels.

The plurality of pixels respectively include a switch Q connected to the gate line, and a liquid crystal capacitor Cx and a storage capacitor Cst connected thereto. The storage capacitor Cst may be omitted if necessary.

The switch Q is formed in the intersection region of the gate line and the data line corresponding to the pixel, and when it is turned on in response to a gate signal from the gate driver 20, a data signal transmitted through the data line is transmitted to the liquid crystal capacitor Cx.

The switch Q includes the source electrode connected to the data line, the drain electrode connected to the pixel electrode of the liquid crystal capacitor Cx, and the gate electrode connected to the gate line.

One terminal of the liquid crystal capacitor Cx as the pixel electrode is connected to the drain electrode of the switch Q, and the other terminal thereof is connected to the common electrode.

The pixel electrode may be made of transparent and electrically conductive indium tin oxide (ITO), and applies the data voltage according to the data signal transmitted through the data driver 30 to the liquid crystal capacitor Cx when the gate signal of a gate-on voltage is transmitted to the gate electrode of the switch Q through the gate line. Also, the common electrode may also be made of ITO to apply a common voltage VCOM to the liquid crystal capacitor Cx.

The storage capacitor Cst has a function of storing and maintaining the data voltage according to the data signal applied to the pixel electrode during a predetermined time, and changes the arrangement state of the liquid crystal layer in the liquid crystal capacitor Cx through charging and discharging, thereby controlling the light transmittance of the pixel. That is, one terminal of the storage capacitor Cst is connected to one terminal of the liquid crystal capacitor Cx and the drain electrode of the switch Q, and the other terminal thereof is connected to common voltage supply lines Vcom1 to Vcomn that are connected to a plurality of pixels to receive the common voltage.

Accordingly, both terminals of the storage capacitor Cst are respectively supplied with the data voltage according to the data signal applied to the pixel electrode and the common voltage VCOM applied to the common electrode during the turn-on period of the switch Q. As a result, the storage capacitor Cst is configured to store the voltage corresponding to the voltage difference at the terminals.

The gate driver 20 generates a plurality of gate signals, transmits them to the gate lines connected to the plurality of pixel rows of the display unit 10, and selects a plurality of pixels provided in the display unit 10.

The gate driver 20 may include a shift register sequentially generating the gate signals in response to a start signal among a gate driving control signal CONT1 from the controller 50 and a level shift to shift the voltages of the gate signals into voltage levels suitable for driving a plurality of pixels.

The data driver 30 samples an image data signal according to a data driving control signal CONT2 from the controller 50, and latches the sampled image data signal by one line to convert the latched image data signal into a gamma voltage and to supply the image data signal that is converted into the gamma voltage to the plurality of selected pixels by the gate signal through the data line as an analog signal type.

The common voltage generator 40 provides the common voltage VCOM through a plurality of common voltage supply lines Vcom1 to Vcomn connected to a plurality of pixel rows of the display unit 10. That is, the common voltage VCOM of the same level is provided to a plurality of pixels arranged in the display unit 10.

In FIG. 1, the common voltage VCOM transmitted through the common voltage supply lines Vcom1 to Vcomn as a voltage that is commonly transmitted to a plurality of pixels is swung between the first level and the second level opposite to the polarity of the data voltage corresponding to the data voltage having the polarity that is inverted according to the pixel row.

The controller 50 arranges video signals transmitted from the outside into image data signals of red, green, and blue. The controller is further configured to transmit the image data signals to the data driver 30, and supply a data driving control signal CONT2 to sequentially drive a plurality of pixels according to the pixel row to the data driver 30. Furthermore, the controller 50 generates and transmits the gate driving control signal CONT1 controlling the driving of the gate driver 20.

The data driving control signal CONT2 may include a source shift clock signal SSC, a source output enable signal SOE, and a polarity inversion signal POL. Furthermore, the gate driving control signal CONT1 may include a start pulse signal SSP, a scan shift clock signal SSC, and a scan output enable signal SOE.

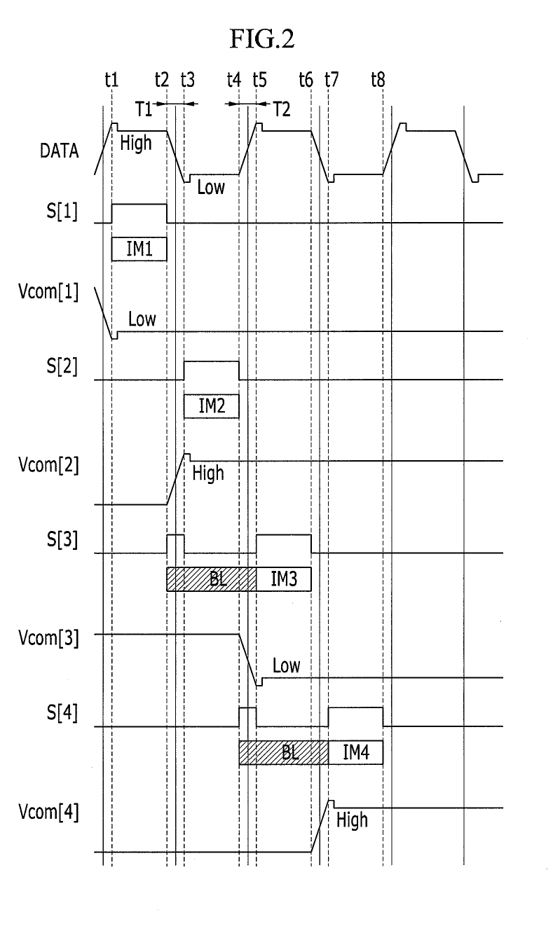

FIG. 2 is a driving waveform diagram of a driving method of a liquid crystal display (LCD) according to some embodiments driven in a normally white mode.

In a driving method according to some embodiments, a data voltage according to a data signal corresponding to a pixel row is transmitted to a plurality of pixels according to the passage of time.

As shown in the driving waveform of FIG. 2, the polarity of the data voltage is inverted between the first level and the second level with a predetermined cycle according to the pixel row.

The predetermined cycle is a period in which the corresponding data voltage is supplied to the plurality of pixels included in one pixel row. If the predetermined cycle is finished, the data voltage having the polarity that is inverted is supplied to a plurality of pixels included in the next pixel row.

The first level and the second level are not limited. Furthermore, a voltage of an upper high potential degree is commonly referred to as the first level and a voltage of a lower low potential degree is commonly referred to as the second level with reference to a predetermined reference voltage level.

FIG. 2 shows the polarity of the data voltage from the first pixel row to the fifth pixel row and the line inversion. However this illustration is only a partial representation, and the data voltages transmitted from the first pixel row to the final pixel row are transmitted to a plurality of pixels of the display unit 10 during one frame period while executing the polarity inversion between the first level and the second level.

The common voltage VCOM transmitted to a plurality of pixels of the display unit 10 of the liquid crystal display (LCD) according to some embodiments is transmitted as a fixed predetermined voltage to a plurality of pixels included in all pixel rows during one frame.

The common voltage is transmitted to each pixel row with the polarity that is opposite to the polarity of the data voltage transmitted to each pixel row such that the common voltage is transmitted with the polarity that is inverted opposite to the polarity, of the data voltage from one pixel row to the next pixel row when the polarity of the data voltage is inverted from one pixel row to the next pixel row.

For example, as illustrated in FIG. 2, the polarity of the data voltage that is sequentially transmitted to the first pixel row, the second pixel row, the third pixel row, and the fourth pixel row during each period of a time t1 to a time t2, a time t3 to a time t4, a time t5 to a time t6, and a time t7 to a time t8 is inverted between a high voltage of the first level and a low voltage of the second level.

If the data voltage is transmitted to the first pixel row with the high voltage of the first level, the common voltage Vcom[1] transmitted to the plurality of pixels of the first pixel row is steadily transmitted with the low voltage of the second level opposite to the polarity of the data voltage. Likewise, the common voltages Vcom[2], Vcom[3], and Vcom[4] that are sequentially transmitted to a plurality of pixels included in the remaining pixel rows are shifted opposite to the polarity of the data voltage applied with the line inversion corresponding to the line inversion of the data voltage.

The polarity of the data voltage is inverted during the time t2 to the time t3, the time t4 to the time t5, and the time t6 to the time t7 such that the common voltages supplied to the pixel row in the period are shifted to the voltage of the inverted polarity compared with the previous transmitted common voltage. The common voltages, including the shift, are then transmitted.

According to some embodiments as illustrated in FIG. 2, the corresponding data voltage having the polarity of the high level as the first level is transmitted to the plurality of pixels in the first pixel row at the time t1. For example, the common voltage Vcom[1] transmitted to the plurality of pixels of the first pixel row is opposite in polarity to the data voltage. As a result, the common voltage Vcom[1] exhibits the polarity of the low level as the second level.

The first gate signal S[1] is transmitted through the gate line connected to the first pixel row during the period from the time t1 to the time t2, and the gate-on voltage level turning on the switch included in the pixel is transmitted.

In the liquid crystal display (LCD) according to some embodiments as illustrated in FIG. 1, the switch Q included in a plurality of pixels of the display unit 10 may be made of a NMOS thin film transistor, and the gate-on voltage may be a voltage of a predetermined high level. However, this is just one exemplary embodiment, and the gate-on voltage level may be changed according to the kind of the thin film transistor.

If the first gate signal S[1] is transmitted to the plurality of pixels of the first pixel row as the voltage of the predetermined high level during the period of the time t1 to the time t2, the switches Q included in a plurality of pixels are turned on, and the data voltage according to the corresponding data signal is applied through the source electrode, thereby displaying the images.

Accordingly, the period of the time t1 to the time t2 is a first image display period IM1 in which the image is displayed at the plurality of pixels included in the first pixel row.

After the data voltage is transmitted to the first pixel row during the first image display period IM1, the polarity of the data voltage is inverted during the predetermined period of the time t2 to the time t3 and is transmitted to the plurality of pixels included in the second pixel row.

The polarity of the common voltage Vcom[2] transmitted to the second pixel row is inverted to be opposite to the polarity of the data voltage during the period in which the polarity of the data voltage is inverted and supplied at the time t2 to the time t3. This period of inversion is referred to as the first swing period T1.

The data voltage transmitted to the plurality of pixels included in the second pixel row is swung from the high level voltage of the first level to the low level of the second level during the swing period T1 such that the polarity of the common voltage Vcom[2] transmitted to the second pixel row is swung from the low level of the second level to the high level voltage of the first level.

After the corresponding data voltage of the low level as the second level is transmitted to a plurality of pixels included in the second pixel row, the second gate signal S[2] is transmitted with the pulse of the gate-on voltage level through the gate line connected to the second pixel row during the period of the time t3 to the time t4. Thus, the high level pulse of the gate-on voltage is transmitted to the gate electrode of the switch Q of the plurality of pixels included in the second pixel row such that the switch Q is turned on. As a results, the corresponding data voltage is transmitted to the second pixel row.

The period of the time t3 to the time t4 in which the switch of the plurality of pixels included in the second pixel row is turned-on is a second image display period IM2 in which the data voltage is transmitted such that the image is displayed.

Next, a period of the time t4 to the time t5 is a period in which the polarity of the data voltage that is transmitted to the third pixel row is swung from the previous second level to the first level. Likewise, the polarity of the common voltage Vcom[3] that is transmitted to the third pixel row is inverted to the opposite polarity corresponding to the polarity of the data voltage that is transmitted to the third pixel row. That is, the polarity of the common voltage Vcom[3] that is transmitted to the third pixel row is inverted into the polarity from the first level to the second level. In this way, a period of the time t4 to the time t5 in which the polarity of the data voltage and the common voltage Vcom[3] that are transmitted to the third pixel row is inverted is referred to as the second swing period T2.

This process is repeated such that the data voltage is sequentially supplied from the first pixel row to the final pixel row during one frame period.

In the liquid crystal display (LCD) and the driving method thereof according to an exemplary embodiment of the present invention, to remove the sticking and the after-image effect that are generated when displaying the image, the black data is not directly inserted halfway through the image data signal being displayed. Furthermore, the gate signal of the gate-on voltage level that is transmitted to the corresponding pixel row and the other pixel row during the swing periods T1 and T2 or the predetermined period before the swing period is appropriately plus-controlled to turn on the switch. Therefore, the plus control of the gate-on voltage level of the gate signal may be controlled according to the image mode of the display unit.

The gate signal transmitted to the other pixel row is previously transmitted with the pulse of the gate-on voltage level during the swing period of the corresponding pixel row or the predetermined period before the swing period as well as the period in which the pulse of the gate-on voltage level is transmitted to receive the data voltage for displaying the image.

Here, a period in which the gate signal is transmitted with the gate-on voltage level to turn on the switch of the pixel corresponding to the swing period of the previous other pixel row or the predetermined period before the swing period to insert the black image is referred to as an open period. The open period may be a period before the image display period in which the gate signal is transmitted with the gate-on voltage level to display the image corresponding to the pixel row.

In the waveform diagram of FIG. 2, after the first image display period IM1 in which the image is displayed according to the data voltage transmitted to the first pixel row, and as an exemplary embodiment, a gate signal S[3] may be transmitted to the different pixel row from the pixel row. That is, the third pixel row, is driven with the high level of the gate-on voltage during the first swing period T1.

Thus, the switches of the plurality of pixels included in the third pixel row are turned on according to the gate signal S[3] during the first swing period T1, thereby receiving the data voltage transmitted during the first swing period T1.

If the data voltage transmitted during the first swing period T1 is transmitted through the source electrode of the switches of the plurality of pixels included in the third pixel row, the storage capacitor Cst of the pixels of the third pixel row store or maintain the voltage corresponding to the voltage difference between the transmitted data voltage and the common voltage Vcom[3] applied to the third pixel row.

Here, the data voltage transmitted during the first swing period T1 is inverted such that it is swung from the first level to the second level, and the common voltage Vcom[3] is applied to the third pixel row during the first swing period T1 as the first level such that the voltage difference between the data voltage transmitted to the third pixel row and the common voltage Vcom[3] is at a maximum level.

Each storage capacitor of the plurality of pixels included in the third pixel row stores the voltage corresponding to the maximum voltage difference during the first swing period T1, that is, the open period of the third gate signal S[3]. Although the gate signal S[3] of the third pixel row is changed into the gate-off voltage, the voltage is maintained until the data voltage according to the video signal corresponding to the third pixel row is transmitted. That is, each storage capacitor of the plurality of pixels included in the third pixel row stores and maintains the voltage corresponding to the maximum voltage difference during the period of the time t2 to the time t5, and arranges the liquid crystal layer of each liquid crystal capacitor of the plurality of pixels, and thereby the third pixel row is displayed with the black image during the period in the normally white mode. Here, the period may be referred to as a black insertion period BL. If the image display mode of the display unit 10 is the normally black mode, the open period of the third pixel row may be changed by controlling the pulse of the third gate signal S[3] transmitted with the gate-on voltage level. The driving of the normally black mode will be described later.

On the other hand, after the black insertion period BL for the plurality of pixels included in the third pixel row has passed, if the third gate signal S[3] is again transmitted with the gate-on voltage level at the time t5, each switch in the plurality of pixels included in the third pixel row is turned on, and the data voltage according to the video signal corresponding to the third pixel row is transmitted. Here, it may be confirmed that the polarity of the data voltage is the high level corresponding to the first level.

The period between the time t5 and the time t6, that is, during the third image display period IM3, a plurality of pixels included in the third pixel row display the images according to the supplied data voltage.

In the driving process described above, each switch of the plurality of pixels included in the fourth pixel row may be turned-on in response to the fourth gate signal S[4] of the gate-on voltage level during the second swing period T2. As a result, the data voltage that is inverted from the second level to the first level at the second swing period T2 is transmitted to the fourth pixel row. The common voltage Vcom[4] transmitted to the fourth pixel row during the second swing period T2 is the second level such that the voltage difference between the data voltage stored to each storage capacitor of the plurality of pixels included in the fourth pixel row and the common voltage Vcom[4] is at a maximum level. Therefore, the plurality of pixels included in the fourth pixel row are stored and maintained with the maximum voltage during the period from the second swing period T2 to the time t7 in the normally white mode, thereby displaying the black image.

According to the driving method of some embodiments, although the black data to display the black image to a plurality of pixels included in the display unit 10 is not written, the black screen may be made by adjusting the time of the pulse level of the gate signal transmitted to each pixel row.

In the normally white mode according to the embodiments illustrated in the waveform diagram of FIG. 2, the pixel row in which the switch of the pixel is turned-on during the period in which the polarity of the data voltage transmitted to the i-th pixel row is swung is set as the even-numbered pixel row following to the i-th pixel row. For example, the (i+2)-th pixel row may be set as the pixel row in which the switch of the pixel is turned-on during the period in which the polarity of the data voltage transmitted to the i-th pixel row is swung. However this is just one exemplary embodiment and the operation of the driving scheme is not limited thereto.

Since the polarity of the data voltage is inverted according to the pixel row and the polarity of the common voltage applied to the corresponding pixel row, in the embodiments illustrated in FIG. 2, the open period according to the gate signal transmitted to the even-numbered pixel row following the i-th pixel row corresponds with the swing period of the data voltage. However, according to some embodiments, the odd-numbered pixel row following the i-th pixel row may be set. For example, the open period according to the gate signal transmitted to the (i+3)-th pixel row may be set up as a predetermined period before the swing period.

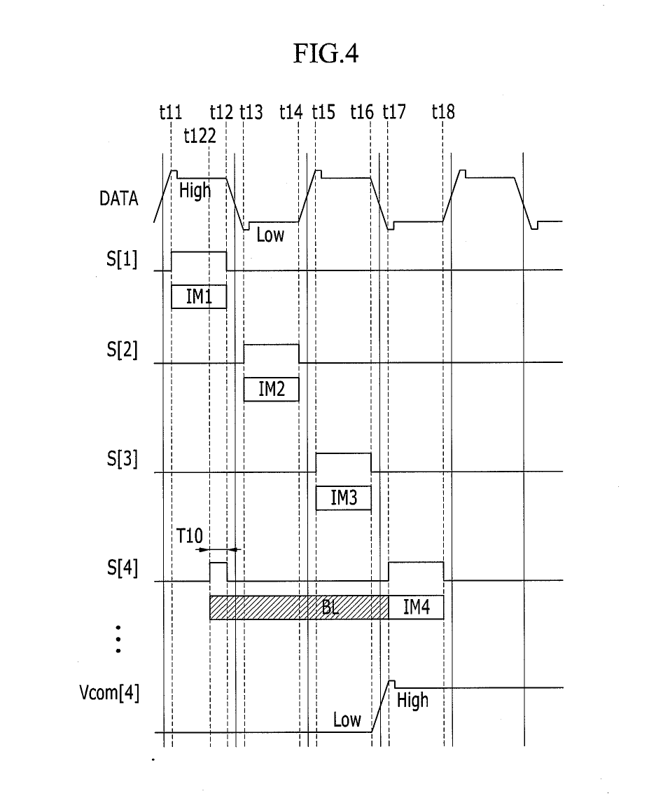

This is to adjust the turn-on time of the gate signal transmitted to the corresponding pixel row for the voltage that is stored and maintained by the storage capacitor of the plurality of pixels included in the odd-numbered pixel row following the i-th pixel row to be the maximum difference value between the data voltage and the common voltage applied to the corresponding pixel row in the normally white mode. The detailed description thereof will be given with reference to FIG. 4.

According to some embodiments, while the black image is inserted to suppress the after-image or the sticking, to reduce the unnecessary power consumption and to realize the image according to the data voltage to be displayed to the original pixel row, it is preferable that the pixel row in which the switch is turned-on is selected by an inversion of two lines to three lines.

In the embodiments illustrated in FIG. 2, the swing period of the predetermined pixel row and the open period of the gate signal transmitted to the other pixel row are determined such that they correspond. However, the driving operation is not limited thereto, and the swing period and the open period may be different from each other.

According to some embodiments, the open period of the gate signal transmitted to the predetermined pixel row may be determined as the period in which the data voltage transmitted to the previous pixel row is applied such that each switch of a plurality of pixels are turned-on during the open period for the voltage capable of displaying the black image to be stored and maintained in each storage capacitor of a plurality of pixels.

Accordingly, as shown in FIG. 2, in the normally white mode, the voltage with which the black image is displayed is the voltage of the maximum difference between the data voltage applied to the previous other pixel row and the common voltage of the corresponding pixel row, such that it is preferable that the finishing point of the open period of the gate signal transmitted to the corresponding pixel row is the time that the difference between at least the data voltage and the common voltage is transmitted is at a maximum. According to some embodiments, it may be confirmed that the difference between the voltage of the data voltage of the previous pixel row transmitted in the corresponding pixel row and the voltage of the common voltage of the corresponding pixel row is maximum in the time t3 or the time t5 as the finishing point of the open period of the third gate signal S[3] or the fourth gate signal S[4].

According to some embodiments, the generated sticking or the after-image effect may be suppressed in the image expression of the pixel, like the display of the black image through the insertion of the black data. However, the black data is not actually inserted in the open period of the gate signal transmitted to a plurality of pixel rows such that the problems associated with luminance of the corresponding pixel row is decreased by the insertion of the black data. Furthermore, the power consumption increase as result of an increased frequency according to the conventional systems may be remedied.

Furthermore, in the liquid crystal display (LCD), a user may arbitrarily determine the open period of a plurality of gate signal such that there is benefit to the capability of adjusting the black insertion period of the pixel row. Accordingly, the instant after-image effect may be improved without the reduction of the aperture ratio of the pixel.

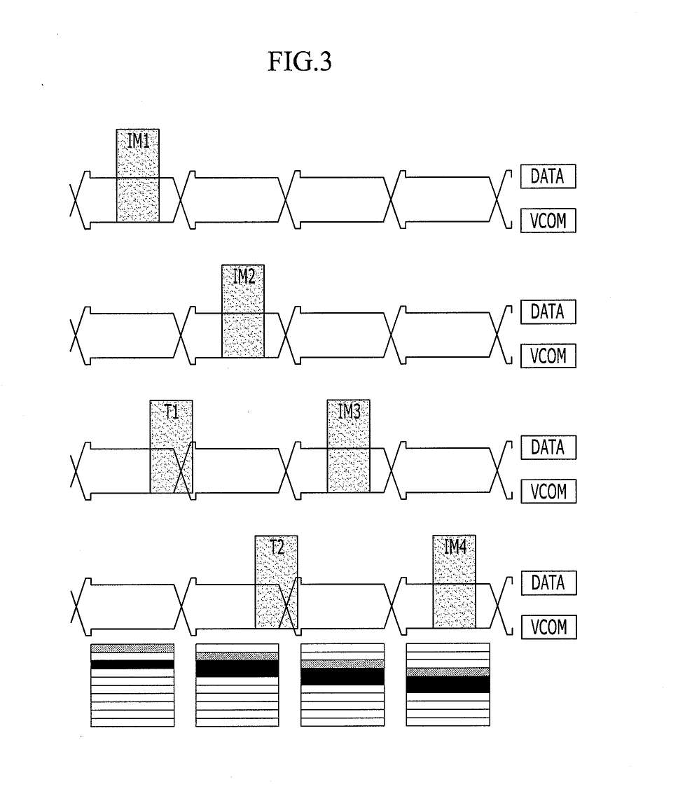

FIG. 3 is a view showing a display of an image of a display unit according to the driving waveform diagram of FIG. 2.

FIG. 3 shows polarities of a data voltage DATA and a common voltage VCOM transmitted to a plurality of pixel rows included in a display unit 10 as a line unit expression and simultaneously an image display period and a black insertion period in which an image of a corresponding pixel row is displayed.

As described in FIG. 2, each pixel row displays the image according to the data voltage in the image display period, and a black image is displayed during a predetermined black insertion period before the image display period. The black insertion period may adjust the starting point and the length of the open period of the gate signal transmitted to the corresponding pixel row.

Image display periods IM1 to IM4 from the first pixel row to the fourth pixel row are sequentially shown among one frame period in which the image is displayed from the first pixel row to the final pixel row in FIG. 3.

The embodiments illustrated in FIG. 3 show the open period and the image display period of the gate signal that are set up with two line intervals, similar to the embodiments of FIG. 2.

As illustrated in FIG. 3, the open period of the third gate signal is the same as the first swing period T1 in which the data voltage of the first pixel row is supplied to the second pixel row while inverting the polarity.

Each switch of the pixel included in the third pixel row is turned on in response to the gate signal during the open period such that the data voltage that is inverted during the open period is received.

Thus, the voltage according to the difference between the common voltage applied to the third pixel row during the open period and the transmitted data voltage is stored in each pixel of the third pixel row. Here, the voltage is the voltage according to the maximum voltage difference such that the black screen is displayed in a normally white mode. As illustrated in FIG. 3, referring to the display unit shown in the lower end, the black screen is displayed in the third pixel row in synchronization with the open period (i.e., the first swing period T1). It may therefore be confirmed that the black screen of the third pixel row is maintained until the image corresponding to the third pixel row is displayed in the third image display period IM3.

The sustain period of the black screen may be adjusted for the user by determining the open period of the gate signal transmitted to the corresponding pixel row.

FIG. 2 and FIG. 3 show the waveform diagram and the image according to the driving process in the third pixel row and the fourth pixel row. However the gate signal transmitted in the entire pixel row of the display unit 10 during one frame period is transmitted with the gate-on voltage level during the open period and the image display period, and each pixel row may have a predetermined black insertion period before the original image display period sequentially corresponding to the open period per row.

FIG. 4 illustrates a driving waveform diagram of a driving method of a liquid crystal display (LCD) according to some embodiments.

The waveform diagram of FIG. 4, which differs from the waveform diagram of FIG. 2, shows that the gate signal transmitted to the pixel row when the pixel row in which the switch of the pixel is turned-on in the period in which the polarity of the data voltage transmitted to the i-th pixel row is swung to be transmitted to the next pixel row is set up as the (i+3)-th pixel row.

Accordingly, in embodiments illustrated in FIG. 4, the swing period in which the polarity of the data voltage transmitted to the first pixel row and the open period of the gate signal S[4] transmitted to a plurality of pixels of the fourth pixel row following the first pixel row do not correspond with to each other. The open period in which the gate signal S[4] transmitted to the fourth pixel row is transmitted with the gate-on voltage level to turn on the switch of the plurality of pixels included in the fourth pixel row is a predetermined period directly before the swing period. That is, the open period T10 of the gate signal S[4] transmitted to the fourth pixel row as the period of the time t122 to the time t12 is different from the swing period (the period of the time t12 to the time t13).

Thus, a plurality of pixels included in the fourth pixel row receive the data voltage of the first level that is applied to the first pixel row during the open period T10 of the time t122 to the time t12. During this period, the common voltage Vcom[4] applied to the plurality of pixels of the fourth pixel row is the second level such that each storage capacitor of the plurality of pixels included in the fourth pixel row stores and maintains the voltage of the difference between the data voltage of the first level and the common voltage Vcom[4] of the second level of the fourth pixel row. The voltage is also the voltage according to the maximum voltage difference such that it is displayed as the black image in the normally white mode. Accordingly the period of the time t122 to the time t17 becomes the black insertion period of the fourth pixel row. In this driving method, the black insertion period and the image display period are sequentially executed from the first pixel row to the final pixel row, thereby forming one frame.

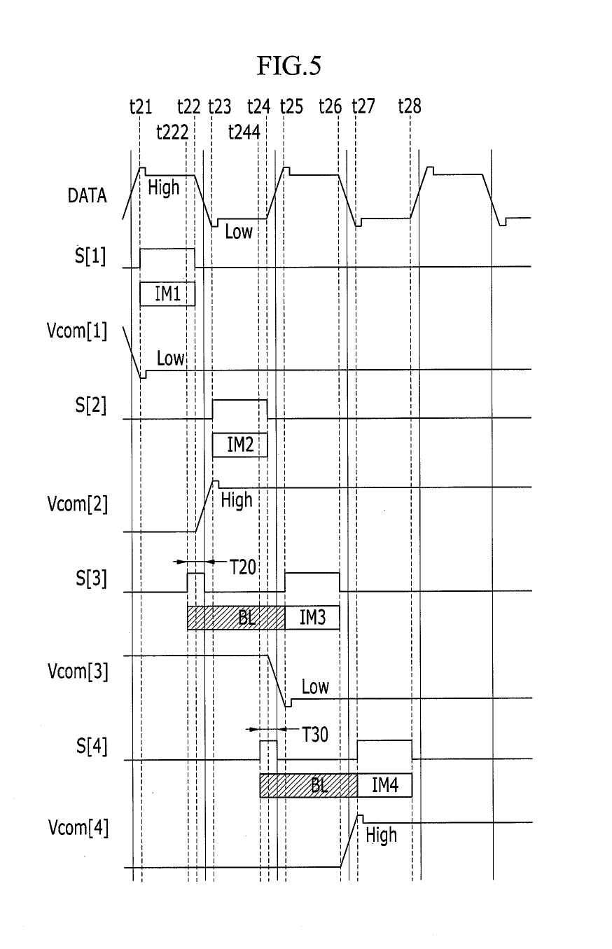

FIG. 5 is a driving waveform of a driving method of a liquid crystal display (LCD) according to some embodiments which is driven by a normally black mode.

FIG. 5 is similar to the exemplary embodiment of FIG. 2, and shows a case in which the driving method of the display unit 10 is the normally black such that the overlapping description is omitted.

According to the embodiments illustrated in FIG. 5, the driving method of the display unit 10 is the normally black mode such that the black insertion period of the predetermined pixel row must be included in the range in which the difference between the data voltage of the previous pixel row transmitted to the corresponding pixel row and the common voltage of the corresponding pixel row is the minimum value or is at least capable of displaying the black image.

Accordingly, when removing the after-image or the sticking effect by realizing the black image by two line intervals in FIG. 5, the polarity of the data voltage transmitted to the first pixel row is inverted when transmitted to the next pixel row. At this time, the swing period is the period of the time t22 to the time t23.

During the half of the swing period or a predetermined period directly before the swing period including the half period of the swing period, the gate signal S[3] transmitted to the third pixel row is transmitted to the gate-on voltage level.

That is, the open period T20 of the gate signal S[3] transmitted to the third pixel row does not correspond with the swing period and is started at the time t222. Therefore, the open period T20 is set up as approximately a half period of the swing period. This is just one exemplary embodiment, and the starting point of the open period T20 may be quickly set up corresponding to the arbitrary adjustment of the black insertion period.

The switch of a plurality of pixels included in the third pixel row is turned on in response to the gate signal S[3] transmitted to the third pixel row during the open period T20. Here, the polarity of the data voltage transmitted to a plurality of pixels during the turn-on period is the first level or is a level corresponding to the intermediated level that is decreased from the first level to the second level. Furthermore, the polarity of the common voltage Vcom[3] transmitted to the third pixel row during the same period (the period T20) is the first level.

Accordingly, the voltage that is stored and maintained by each storage capacitor of the plurality of pixels of the third pixel row at the open period T20 is the minimum voltage corresponding to the difference between the data voltage and the common voltage Vcom[3], or the low voltage of the degree that is displayed as the black image.

During the time that the voltage is stored and maintained by the storage capacitor, if the liquid crystal layer of each pixel is arranged by the voltage, the third pixel row is displayed with the black image in the normally black mode.

The black insertion period BL that is displayed with the black image in the third pixel row is the period from the time t222 at which the open period T20 of the third gate signal S[3] is transmitted with the gate-on voltage level is started to the time t25 as the time directly before the third image display period IM3 according to the image data signal according to the third pixel row.

Likewise, the open period of the gate signal transmitted to each row in the other pixel row is determined as described above, and the minimum voltage or the voltage of the low degree capable of realizing the black image is stored or maintained by the storage capacitor of each pixel row directly before the period in which the image of the corresponding pixel row is displayed. As a result, the black image is displayed. In the case of the normally black mode compared with the normally white mode, the open period of the gate signal of each pixel row is relatively short such that the reduction width of the power consumption may be large.

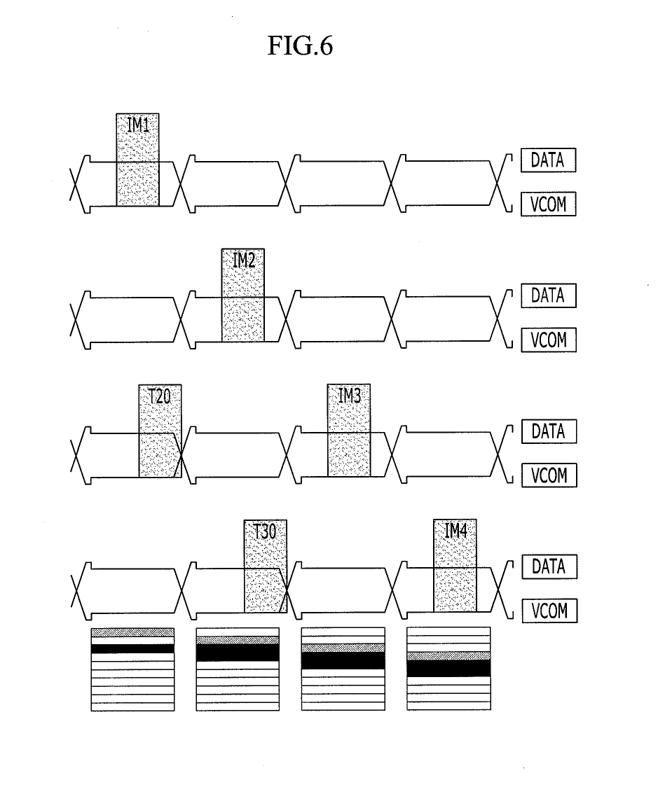

FIG. 6 is a view of an image display of a display unit according to the driving waveform of FIG. 5. According to FIG. 6, it is set up that the open periods T20 and T30 of the gate signal of the corresponding pixel row in which the black insertion period is started includes a half period of the swing period of the previous other pixel row of the corresponding pixel row, when sequentially displaying the image according to each pixel row from the first image display period IM1 in the normally black mode.

That is, in FIG. 6, the black insertion period is provided before the image display period IM3 in which the image of the third pixel row is displayed in the third pixel row, and the black insertion period is started by the open period T20 of the gate signal S[3] transmitted to the third pixel row. The open period T20 includes a half period of the swing period of the data voltage transmitted to the first pixel row, and may be set up to include the predetermined period directly before the swing period.

In FIG. 6, the starting point of the open period T20 of the gate signal S[3] may overlap the image display period IM1 of the first pixel row, however it is not limited thereto. Preferably, the finishing point of the open period T20 of the gate signal S[3] may occur when the voltage difference between the data voltage when inverting to the second level and the common voltage Vcom[3] transmitted to the third pixel row is the minimum voltage, or the low voltage of the degree displaying the black image in the normally black mode.

According to some embodiments a driving apparatus of a liquid crystal display (LCD) that removes an after-image or sticking effect while maintaining luminance of an appropriate degree in an image display of a liquid crystal display (LCD), and a driving method thereof is disclosed. A driving apparatus of a liquid crystal display (LCD) capable of improving an after-image or sticking effect or improving an instant after-image without the insertion of black image data while screen data is input, or reducing the aperture ratio of the pixel as described in the conventional liquid crystal display (LCD) driving schemes is disclosed.

Furthermore, a liquid crystal display (LCD) of high image quality is provided by preventing an increase in frame frequency for realizing driving with low power consumption, and by preventing an after-image or sticking effect. Therefore, the LCD displays the images with the appropriate luminance.

The technical problems resolved by the present invention are not limited to the foregoing technical problems. Other technical problems, which are not described, can clearly be understood by those skilled in the art from the following description of the various embodiments.

A liquid crystal display (LCD) according to some embodiments includes: a display unit including a plurality of pixels arranged in a matrix, a gate line respectively connected to a plurality of pixel rows, and a data line respectively connected to a plurality of pixel columns; a gate driver generating and sequentially transmitting a plurality of gate signals to a plurality of pixel rows through the gate line by row to turn on a switch included in the pixel. The LCD further includes a data driver applying the data voltage according to an image data signal to the pixel during a period in which the switch is turned on; and a common voltage generator generating and applying a common voltage having a polarity that is opposite to the polarity of the data voltage to the pixel.

The period in which the switch is turned on includes a first period and a second period that are separated from each other by a period in which the data voltage is transmitted to at least one pixel row. During the first period, as a voltage according to a difference between the data voltage transmitted to the pixel and the common voltage applied to the pixel, a voltage displaying a black image according to a liquid crystal mode of the display unit is stored to the pixel.

When the liquid crystal mode of the display unit is a normally white mode, the voltage according to the difference between the data voltage transmitted to the pixel and the common voltage applied to the pixel may be a maximum voltage.

When the liquid crystal mode of the display unit is a normally black mode, the voltage according to the difference between the data voltage transmitted to the pixel and the common voltage applied to the pixel may be a minimum voltage or in a voltage range displaying a black image.

When the liquid crystal mode of the display unit is a normally white mode, the first period may include a swing period in which the polarity of the data voltage transmitted to the pixels included in another pixel row among a plurality of pixel rows before the pixel row including the pixel is inverted.

The finishing point of the first period may accord with a finishing point of the swing period. When the liquid crystal mode of the display unit is a normally black mode, the first period may include a portion of a swing period in which the polarity of the data voltage transmitted to the pixels included in another pixel row among a plurality of pixel rows before the pixel row including the pixel is inverted, or may be a predetermined period directly before the swing period.

The other pixel row may be a second previous pixel row or a third previous pixel row of the pixel row including the pixel. The gate signal transmitted to the pixel row including the pixel row may be transmitted with a gate-on voltage level during the first period and the second period. During the second period, the data voltage according to the image data signal corresponding to the pixel may be applied.

The period from a time that the first period is started to a time that the second period is started may be a black insertion period. The voltage stored in the pixel may be maintained during the period from a time that the first period is started to a time that the second period is started and that is a black insertion period.

The gate signal transmitted to the pixel row including the pixel row may be a gate-on voltage level during the first period and the second period. The finishing point of the first period is a time that the voltage difference between the swing data voltage and the common voltage is a maximum voltage difference when the display unit is a normally white mode. When the display unit is a normally black mode, it corresponds to a time that the voltage difference between the swing data voltage and the common voltage is in the voltage range displaying the black image.

According to some embodiments, the finishing point of the first period may be a time that the voltage difference between the swing data voltage and the common voltage is the minimum voltage difference when the display unit is a normally black mode.

The gate driver may generate and transmit the gate signal of a gate-on voltage level turning on a gate electrode of the switch during the first period and the second period.

The data driver may transmit the data voltage according to an image data signal having a polarity that is sequentially inverted with the first level and the second level by row to the plurality of pixel rows, and the common voltage generator may transmit a common voltage having a polarity that is inverted to the opposite polarity of the data voltage when the polarity of the data voltage is inverted and transmitted to the corresponding pixel among the plurality of pixel rows.

The first period in which the switch of the pixel is turned on may overlap a period in which the data voltage according to the image data signal is applied to the pixel included in the other pixel row among a plurality of pixel rows before the pixel row including the pixel.

The liquid crystal display (LCD) may further include a controller transmitting the image data signal to the data driver, and generating and transmitting a data driving control signal and a gate driving control signal to the data driver and the gate driver.

The controller may invert the polarity of the data voltage output from the data driver according to the pixel row, and may invert the polarity of the common voltage generated in the common voltage generator to the opposite polarity of the data voltage according to the pixel row.

According to some embodiments, a method for driving a liquid crystal display (LCD) including a plurality of pixels and a black insertion period before an image display period displaying a corresponding image to a plurality of pixel rows is disclosed. The method includes: transmitting a gate signal of a gate-on voltage level to a gate line connected to a predetermined pixel row at a predetermined start period of the black insertion period, and transmitting the gate signal of the gate-on voltage level to the gate line connected to the predetermined pixel row at the image display period. During the start period, as a voltage according to a difference between the data voltage transmitted to a plurality of pixels included in the predetermined pixel row and the common voltage applied to a plurality of pixels, the voltage realizing a black image according to a liquid crystal mode of the display unit is stored to the plurality of pixels.

When the liquid crystal mode of the display unit is a normally white mode, the start period may include a swing period in which the polarity of the data voltage transmitted to the pixels included in the other pixel row among a plurality of pixel rows before the predetermined pixel row is inverted.

The finishing point of the start period may accord with the finishing point of the swing period. When the liquid crystal mode of the display unit is a normally black mode, the start period may include a portion of a swing period in which the polarity of the data voltage transmitted to the pixels included in the other pixel row among a plurality of pixel rows before the predetermine pixel row is inverted, or is a predetermined period directly before the swing period. The start period may include an initial half period of the swing period.

The voltage stored in a plurality of pixels included in the predetermined pixel row during the start period may be maintained during the black insertion period. The start period may overlap a period in which the data voltage according to the image data signal is applied to a plurality of pixels included in the other pixel row among a plurality of pixel rows before the predetermined pixel row.

According to some embodiments, a method of displaying an image in the liquid crystal display (LCD) is disclosed. The image may be displayed with correct luminance and simultaneously the after-image or the sticking effect may be removed such that a high quality clear screen may be provided.

Also, without the insertion of the black image data or the reduction of the aperture ratio of the pixel, the after-image or the sticking may be improved. Therefore, the problems associated with reduction of the luminance, the increasing of the driving frequency, and the increasing of the power consumption according to the conventional systems may be prevented. Accordingly the clear image may be displayed with low consumption power.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Also, the material of respective constituent elements described in the specification can be easily selected and substituted from various materials by a person of ordinary skill in the art. Further, a person of ordinary skill in the art can omit part of the constituent elements described in the specification without deterioration of performance or can add constituent elements for better performance. In addition, a person of ordinary skill in the art can change the specification depending on the process conditions or equipment. Hence, the range of the present invention is to be determined by the scope of the appended claims and equivalents thereof.

What is claimed is:

1. A liquid crystal display (LCD) comprising:
a display unit including a plurality of pixels arranged in a matrix;
a plurality of gate lines respectively connected to a plurality of pixel rows;
a plurality of data lines respectively connected to a plurality of pixel columns;
a plurality of switches respectively connected to the plurality of pixels;
a gate driver configured to generate and sequentially transmit a plurality of gate signals to a plurality of pixel rows through the gate lines by row to turn on a switch of the plurality of switches included in the pixel;
a data driver configured to apply the data voltage according to an image data signal to the pixel during a period in which the switch is turned on; and
a common voltage generator configured to generate and apply a common voltage having a polarity that is opposite to a polarity of the data voltage to the pixel,
wherein the period in which the switch is turned on includes a first period and a second period that are separated from each other by a period in which the data voltage is transmitted to at least one pixel row, and
during the first period, a voltage for displaying a black image according to a liquid crystal mode of the display unit is stored in the pixel, wherein the voltage stored in the pixel corresponds to a voltage difference corresponding to a difference between the data voltage transmitted to the pixel and the common voltage applied to the pixel.

2. The liquid crystal display (LCD) of claim 1, wherein, when the liquid crystal mode of the display unit is a normally white mode, the voltage corresponding to the difference between the data voltage transmitted to the pixel and the common voltage applied to the pixel is a maximum voltage.

3. The liquid crystal display (LCD) of claim 1, wherein when the liquid crystal mode of the display unit is a normally black mode, the voltage corresponding to the difference between the data voltage transmitted to the pixel and the common voltage applied to the pixel is a minimum voltage or is within a voltage range for displaying a black image.

4. The liquid crystal display (LCD) of claim 1, wherein when the liquid crystal mode of the display unit is a normally white mode, the first period includes a swing period in which the polarity of the data voltage transmitted to the pixels included in another pixel row among the plurality of pixel rows before the pixel row including the pixel is inverted.

5. The liquid crystal display (LCD) of claim 4, wherein the another pixel row is a second previous pixel row or a third previous pixel row of the pixel row including the pixel.

6. The liquid crystal display (LCD) of claim 4, wherein the finishing point of the first period corresponds with a finishing point of the swing period.

7. The liquid crystal display (LCD) of claim 1, wherein when the liquid crystal mode of the display unit is a normally black mode, the first period includes a portion of a swing period in which the polarity of the data voltage transmitted to the pixels included in another pixel row among a plurality of pixel rows before the pixel row including the pixel is inverted, or is a predetermined period directly prior to a swing period.

8. The liquid crystal display (LCD) of claim 7, wherein the another pixel row is a second previous pixel row or a third previous pixel row of the pixel row including the pixel.

9. The liquid crystal display (LCD) of claim 1, wherein during the second period, a data voltage corresponding to the image data signal for driving the pixel is applied.

10. The liquid crystal display (LCD) of claim 1, wherein a period from a time that the first period is started to a time that the second period is started is a black image insertion period.

11. The liquid crystal display (LCD) of claim 1, wherein the voltage stored in the pixel is maintained during a period from a time that the first period is started to a time that the second period is started.

12. The liquid crystal display (LCD) of claim 1, wherein the gate signal transmitted to the pixel row including the pixel row is a gate-on voltage level during the first period and the second period.

13. The liquid crystal display (LCD) of claim 1, wherein the gate driver is configured to generate and transmit the gate signal of a gate-on voltage level, and wherein the gate-on voltage level is configured to turn on a gate electrode of the switch during the first period and the second period.

14. The liquid crystal display (LCD) of claim 1, wherein the data driver is configured to sequentially transmit the data voltage according to an image data signal having a polarity that is inverted with a first level and a second level by row to the plurality of pixel rows, and
the common voltage generator is configured to transmit a common voltage having a polarity corresponding to the opposite polarity of the data voltage when the polarity of the data voltage is inverted, and wherein the data voltage having the inverted polarity is transmitted to the corresponding pixel row among the plurality of pixel rows.

15. The liquid crystal display (LCD) of claim 1, wherein the first period in which the switch of the pixel is turned on overlaps a period in which the data voltage according to the image data signal is applied to the pixel included in another pixel row among a plurality of pixel rows before the pixel row including the pixel.

16. The liquid crystal display (LCD) of claim 1, further comprising
a controller configured to transmit the image data signal to the data driver, and generate and transmit a data driving control signal and a gate driving control signal to the data driver and the gate driver respectively, wherein the controller inverts the polarity of the data voltage output from the data driver according to the pixel row, and inverts the polarity of the common voltage generated in the common voltage generator to the opposite polarity of the data voltage according to the pixel row.

17. A method for driving a liquid crystal display (LCD) comprising a plurality of pixels, the method including a black insertion period prior to an image display period for displaying a corresponding image to a plurality of pixel rows, comprising:
transmitting a gate signal of a gate-on voltage level to a gate line connected to a predetermined pixel row at a start period of the black insertion period;
transmitting the gate signal of the gate-on voltage level to the gate line connected to the predetermined pixel row at the image display period and
storing a voltage for displaying a black image according to a liquid crystal mode for the display unit to the plurality of pixels during a start period, wherein the voltage stored to the plurality of pixels corresponds to a voltage according to a difference between the data voltage transmitted to a plurality of pixels included in the predetermined pixel row and the common voltage applied to the plurality of pixels.

18. The method of claim 17, wherein, when the liquid crystal mode of the display unit is a normally white mode, the voltage according to the difference between the data voltage transmitted to the pixel and the common voltage applied to the pixel is a maximum voltage.

19. The method of claim 17, wherein, when the liquid crystal mode of the display unit is a normally black mode, the voltage according to the difference between the data voltage transmitted to the pixel and the common voltage applied to the pixel is a minimum voltage or is within the voltage range for displaying a black image.

20. The method of claim 17, wherein, when the liquid crystal mode of the display unit is a normally white mode, the start period includes a swing period in which the polarity of the data voltage transmitted to the pixels included in another pixel row among a plurality of pixel rows before the predetermined pixel row is inverted.

21. The method of claim 20, wherein the another pixel row is a second previous pixel row or a third previous pixel row of the predetermined pixel row.

22. The method of claim 20, wherein a finishing point of the start period corresponds to a finishing point of the swing period.

23. The method of claim 17, wherein, when the liquid crystal mode of the display unit is a normally black mode, the start period includes a portion of a swing period in which the polarity of the data voltage transmitted to the pixels included in the another pixel row among a plurality of pixel rows before the predetermined pixel row is inverted, or is a predetermined period directly before the swing period.

24. The method of claim 23, wherein the start period includes an initial half period of the swing period.

25. The method of claim 23, wherein the another pixel row is a second previous pixel row or a third previous pixel row of the predetermined pixel row.

26. The method of claim 20, wherein the voltage stored in a plurality of pixels included in the predetermined pixel row during the start period is maintained during the black insertion period.

27. The method of claim 17, wherein the start period overlaps a period in which the data voltage according to the image data signal is applied to a plurality of pixels included in the another pixel row among a plurality of pixel rows before the predetermined pixel row.
